(19) United States
(12) Patent Application Publication
(10) Pub. No.: US 2006/0042502 A1
(43) Pub. Date: Mar. 2, 2006

(54) Composition for polishing metal, polishing metod for metal layer, and production method for wafer

(75) Inventors: Takashi Sato, Shiojiri-shi (JP); Ayako Nishioka, Chiba-shi (JP); Novuo Uotani, Shiojiri-shi (JP)

Correspondence Address: SUGHRUE MION, PLLC, 2100 PENNSYLVANIA AVENUE, N.W., SUITE 800, WASHINGTON, DC, 20037, US

(73) Assignee: Showa Denko K.K.

(21) Appl. No.: 10/532,966

(22) PCT Filed: Oct. 31, 2003
(86) PCT No.: PCT/JP03/14026

§ 371 Date: Apr. 27, 2005

Related U.S. Application Data
(60) Provisional application No. 60/426,399, filed on Nov. 15, 2002.

(30) Foreign Application Priority Data
Oct. 31, 2002 (JP) 2002-317705

(51) Int. Cl. C09G 1/08

(52) U.S. Cl. 106/10

(57) ABSTRACT

A metal polishing composition is used for polishing a metal layer and comprises a film forming compound which polymerizes on a surface of the metal layer, forming a polymer film on the surface of the metal layer. A polishing method for the metal layer comprises a step of polishing and planarizing the metal layer using the metal polishing composition. A production method for a wafer comprises a step of polishing and planarizing a metal layer which is formed on top of a wafer that contains recesses so as to fill and cover the recesses, by the polishing method for a metal layer. According to the composition and polishing method, dishing is prevented to improve the planarity, and the polishing rate for polishing metal layers, and particularly copper layers, is improved, enabling high speed polishing at low pressure. Furthermore, because scratching of the metal layer is also prevented, the yield improves.

### CROSS-REFERENCE TO RELATED APPLICATION

This application claims the benefit pursuant to 35 U.S.C. 119(e)(1) of U.S. Provisional Application, No. 60/426,399 filed Nov. 15, 2002.

### TECHNICAL FIELD

The present invention relates to a metal polishing composition using in the polishing of a metal layer, a polishing method for a metal layer, and a production method for a wafer.

This application is based on Japanese Patent Application No. 2002-317705, the content of which is incorporated herein by reference.

### BACKGROUND ART

As the technology relating to ICs (Integrated Circuits) and LSI (Large Scale Integration) has progressed, the operating speed and the scale of integration of such circuits has improved, leading to rapid improvements in the performance of microprocessors and large increases in the capacity of memory chips. Micromachining technology has contributed significantly to these improvements in performance, and chemical mechanical polishing methods, which represent one type of planarization technique, are one example of such micromachining technology. Chemical mechanical polishing methods are used during multi-layer wiring processes for planarizing interlayer insulating films, metal plugs, and metal wiring.

However in recent years, wiring delay problems have lead to copper and copper alloys being tested as potential wiring metals. In methods for producing wiring using copper or a copper alloy, grooves are formed in advance in an interlayer insulating film, a thin barrier metal layer of tantalum or tantalum nitride is formed on the interlayer insulating film if required, and then a damascene method is used to deposit the copper or copper alloy within the grooves. Excess copper or copper alloy, which forms a convex shape on top of the interlayer insulating film is then polished off to planarize the surface and form the wiring.

Examples of possible methods of polishing the copper or copper alloy in the above production method include methods which utilize a polishing agent containing abrasive grains, although because copper and copper alloys are typically soft, if the polishing process is conducted solely with such a polishing agent, then scratches are likely to form on the metal surface, meaning the yield tends to be extremely low. Furthermore, because copper dissolves in etchants, polishing agents containing an etchant are another possibility, although these agents etch not only the excess deposited copper or copper alloy, but also the metal wiring sections themselves, and consequently not only is it difficult to achieve a planar surface, but a phenomenon known as dishing, in which the metal wiring sections are carved out, also develops.

In order to prevent the type of phenomena described above, Japanese Unexamined Patent Application, First Publication No. Hei 8-83780 (claims) discloses a metal polishing composition comprising hydrogen peroxide, benzotriazole and aminoacetic acid, and where necessary also comprising abrasive grains, as a potential polishing agent for polishing metal layers formed from copper or copper alloy. In this metal polishing composition, the benzotriazole forms a protective film on top of the oxidized metal layer, so that when the aforementioned convex section is preferentially removed by mechanical polishing, sections outside of the convex section are resistant to scratching, and both etching of the metal wiring sections and dishing can be prevented. As a result, planarity can be improved, and an efficient method of leaving the metal only in the recessed sections can be provided.

Furthermore, Japanese Unexamined Patent Application, First Publication No. Hei 9-55363 (claims) discloses a metal polishing composition comprising 2-quinolinecarboxylic acid, which reacts with copper to form a copper complex that is only sparingly soluble in water and is mechanically more fragile than copper.

However, although the metal polishing composition disclosed in Japanese Unexamined Patent Application, First Publication No. Hei 8-83780 (claims) is effective in improving planarity and preventing dishing, because the protective effect of the benzotriazole is powerful, the polishing rate decreases markedly. Furthermore, the 2-quinolinecarboxylic acid used in the metal polishing composition disclosed in Japanese Unexamined Patent Application, First Publication No. Hei 9-55363 (claims) is extremely expensive, making the composition difficult to apply in an industrial setting.

In recent years, the parasitic capacity of copper wiring has lead to investigations of the use of Low K materials as interlayer insulating films. A wide variety of inorganic and organic materials have already been developed as Low K materials, although the next generation Low K materials will require a dielectric constant of less than 2.3. It has been suggested that in order to achieve this level of dielectric constant, increasing the porosity of Low K materials is essential, although porous materials provide lower levels of mechanical strength, and are damaged by the polishing pressures employed in conventional CMP methods (see “Advanced CMP Processes and Materials Technology”, Technical Information Association, 2002, p133). However, these conventional polishing methods require high polishing pressures, and at lower pressures, high speed polishing becomes impossible. Accordingly, a polishing agent that is capable of high speed polishing at low pressures has been keenly sought.

### DISCLOSURE OF INVENTION

An object of the present invention is to provide a cheap, industrially applicable metal polishing composition, which prevents dishing, improves planarity, increases the polishing rate for the polishing of metal layers, particularly copper layers, enables high speed polishing to be conducted at low pressure, and improves yields. Another object of the present invention is to provide a polishing method for a metal layer and a production method for a wafer which utilize such a metal polishing composition.

As a result of intensive investigations aimed at resolving the issues described above, the inventors of the present invention discovered that if a metal polishing composition comprising a film forming compound that polymerizes and forms a film on the surface of the metal layer is used during polishing of the metal layer, then the problems described above can be resolved, and they were hence able to complete the present invention.

In other words, the present invention provides a metal polishing composition used for polishing a metal layer, comprising a film forming compound that polymerizes on the surface of the metal layer, forming a polymer film on the surface of the metal layer.

In the metal polishing composition of the present invention, the film forming compound is preferably a compound that polymerizes under catalysis from one or more materials selected from a group consisting of the metal included in the metal layer, oxides of the metal, and ions of the metal.

Furthermore, the film forming compound is preferably at least one compound selected from a group consisting of phenol compounds and aromatic diamine compounds. Phenol compounds containing at least two phenolic hydroxyl groups are even more preferred, and of these compounds containing at least two phenolic hydroxyl groups, one or more compounds selected from a group consisting of catechol, pyrogallol, gallic acid, tannic acid, and polyphenols is particularly desirable. The polyphenol is preferably a tannin.

Furthermore, a metal polishing composition of the present invention preferably also comprises an oxidizing agent, and the polymerization reaction is preferably an oxidation polymerization.

In those cases in which an oxidizing agent is added to the composition, the oxidizing agent is preferably at least one compound selected from a group consisting of oxygen, ozone, hydrogen peroxide, and ammonium persulfate.

The metal polishing composition of the present invention may also comprise an organic acid and/or an amino acid.

In those cases in which an organic acid and/or an amino acid is added to the composition, the organic acid is preferably at least one compound selected from a group consisting of acetic acid, lactic acid, malic acid, citric acid, tartaric acid, glycolic acid, oxalic acid, and phthalic acid.

Furthermore, the metal polishing composition of the present invention preferably also comprises a complex forming compound, which reacts with the metal included in the metal layer, an oxide of the metal, or an ion of the metal, and forms an insoluble complex.

In those cases in which a complex forming compound is added to the composition, the complex forming compound is preferably an azole. Of the possible azoles, benzotriazole is preferred.

In addition, the metal polishing composition of the present invention may also comprise abrasive grains.

If abrasive grains are added, the abrasive grains can utilize at least one material selected from a group consisting of silica, alumina, ceria, and organic abrasive grains.

A metal polishing composition described above may be used as the metal polishing composition for polishing a metal layer that is formed on top of a wafer that contains recesses so as to fill and cover the recesses.

In such cases, a barrier metal layer may be formed on top of the wafer that contains the recesses.

Furthermore, the aforementioned metal included in the metal layer is preferably either copper or a copper alloy.

In those cases where a barrier metal layer is formed, the barrier metal layer is preferably formed from a tantalum based metal.

A polishing method for a metal layer according to the present invention uses a metal polishing composition described above for polishing and planarizing the metal layer.

A production method for a wafer according to the present invention comprises a step in which the method of polishing a metal layer described above is used for polishing and planarizing a metal layer, which is formed on top of a wafer that contains recesses so as to fill and cover the recesses.

### BEST MODE FOR CARRYING OUT THE INVENTION

As follows is a more detailed description of embodiments of the present invention.

First is a description of a metal polishing composition. This metal polishing composition is used for polishing a metal layer. The composition comprises a film forming compound that polymerizes on the surface of the metal layer, forming a polymer film on the surface of the metal layer. The metal polishing composition is typically an aqueous solution.

Examples of the metal layers that can be polished using this metal polishing composition include the metal layer formed on top of wafers containing grooves or openings that form wiring when filled with metal. Examples of the metal included in the metal layer include aluminum, copper, tungsten, nickel, tantalum, tantalum nitride, platinum group metals such as ruthenium and platinum, or alloys of any of these metals. Of the metals listed, copper or copper alloys used in wiring are preferred. The wafer can utilize wafers formed from semiconductors and the like.

Examples of the film forming compound include compounds that selectively polymerize on the metal layer surface, forming a polymer film on the metal layer surface, and compounds that polymerize first, and subsequently selectively adsorb to the metal layer surface by a chemical or physical process. Either of these two types of compounds is suitable, although from the viewpoint of forming a uniform polymer film, compounds that selectively polymerize on the metal layer surface, forming a polymer film on the metal layer surface are preferred.

Of those compounds that selectively polymerize on the metal layer surface, generating a polymer film on the metal layer surface, compounds in which the metal layer participates in the polymerization are preferred, and of these types of compounds, compounds for which the metal of the metal layer, an oxide of the metal, or an ion of the metal are able to act as a catalyst for accelerating the polymerization are preferred from the viewpoint of achieving a high level of selectivity for polymerization on the metal layer surface.

Examples of the polymerization of the film forming compound include oxidation polymerization or condensation polymerization, although in terms of convenience, oxidation polymerization is preferred.

An example of oxidation polymerization is shown by the equation (1) below, which represents the polymerization of phenol. In this polymerization reaction, two phenol molecules react with oxygen and polymerize. In this polymerization reaction, metal ions or the like function as a catalyst, accelerating the oxidation polymerization. Chain-like repetition of this type of polymerization reaction leads to the formation of a polymer film on the surface of the metal layer.

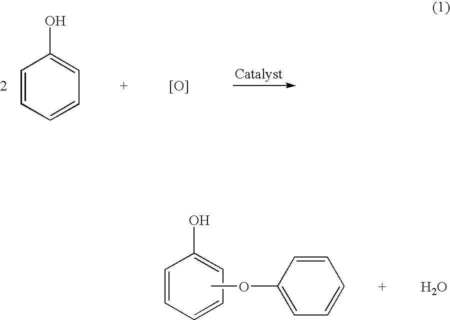

Suitable examples of film forming compounds that can be subjected to oxidation polymerization under the catalysis of metals, metal oxides or metal ions include low molecular weight phenol compounds such as phenol, cresol, catechol, pyrocatechol, hydroquinone, pyrogallol, gallic acid, caffeic acid, tannic acid, ellagic acid, catechin, and pyrocatechin; hydrolysable tannins such as Chinese gallotannin, nutgall tannin, chestnut tannin, tara tannin, gambier tannin, myrobalan tannin, and sumac tannin; condensed tannins such as mimosa tannin, quebracho tannin, wattle tannin, and persimmon tannin; chlorogenic acids such as neochlorogenic acid, isochlorogenic acid, and cryptochlorogenic acid; polyphenols such as lignin, novolak, and polyvinylphenol; and aromatic amines such as pyridine and p-diaminobenzene.

Of the compounds listed above, phenol compounds containing at least two phenolic hydroxyl groups are preferred. Specific examples of such phenol compounds containing at least two phenolic hydroxyl groups include low molecular weight phenol compounds such as cresol, catechol, pyrocatechol, hydroquinone, pyrogallol, gallic acid, caffeic acid, tannic acid, ellagic acid, catechin, and pyrocatechin; hydrolysable tannins such as Chinese gallotannin, nutgall tannin, chestnut tannin, tara tannin, gambier tannin, myrobalan tannin, and sumac tannin; condensed tannins such as mimosa tannin, quebracho tannin, wattle tannin, and persimmon tannin; chlorogenic acids such as neochlorogenic acid, isochlorogenic acid, and cryptochlorogenic acid; and polyphenols such as lignin. Those compounds comprising at least two phenols within each molecule are even more preferred, and include hydrolysable tannins such as Chinese gallotannin, nutgall tannin, chestnut tannin, tara tannin, gambier tannin, myrobalan tannin, and sumac tannin; condensed tannins such as mimosa tannin, quebracho tannin, wattle tannin, and persimmon tannin; chlorogenic acids such as neochlorogenic acid, isochlorogenic acid, and cryptochlorogenic acid; and polyphenols such as lignin. Because these compounds comprise two phenolic groups that can act as sites for polymerization, when polymerization occurs, cross linking occurs rapidly to form a water insoluble polymer, enabling a polymer film to be formed efficiently on the surface of the metal layer.

Furthermore, of the aforementioned phenol compounds containing at least two phenolic hydroxyl groups, in terms of the speed with which the polymer film is formed, catechol, pyrogallol, gallic acid, tannic acid, and polyphenols are preferred. Of the polyphenols, tannins are particularly preferred.

The quantity of the film forming compound within the metal polishing composition is typically within a range from 0.001 to 20% by mass, and preferably from 0.002 to 5% by mass, and even more preferably from 0.005 to 1% by mass. If the quantity is less than 0.001% by mass, then the effects of the composition in suppressing etching and improving the polishing rate may not manifest adequately, whereas even if the quantity exceeds 20% by mass, a proportional improvement in the above effects is not observed, and not only does the composition become uneconomical, but the metal polishing rate may also decrease.

The metal polishing composition preferably also comprises an oxidizing agent. By adding an oxidizing agent, the metal or metal alloy is oxidized, which enables a further improvement in the polishing rate, and an acceleration of the polymerization of the film forming compound.

Examples of suitable oxidizing agents include oxygen, ozone, hydrogen peroxide; alkyl peroxides such as t-butyl hydroperoxide and ethylbenzene hydroperoxide; peracids such as peracetic acid and perbenzoic acid; as well as potassium permanganate, potassium iodate, ammonium persulfate and polyoxo acids. Of these oxidizing agents, from the viewpoint of increasing the polishing rate in a stable manner, at least one compound selected from a group consisting of oxygen, ozone, hydrogen peroxide, and ammonium persulfate is preferred, and hydrogen peroxide, which contains no metal elements and produces decomposition products that are easy to process, is particularly desirable.

The quantity of the oxidizing agent within the metal polishing composition is typically within a range from 0.01 to 30% by mass, and preferably from 0.1 to 20% by mass, and even more preferably from 0.5 to 10% by mass. If the quantity is less than 0.01% by mass, then the addition does not generate the desired effect, whereas if the quantity exceeds 30% by mass, a proportional improvement in the effect is not observed, and the extra oxidizing agent is either wasted, or may even impair the polishing rate.

The metal polishing composition may also comprise an organic acid or an amino acid. Organic acids and amino acids can etch the metal, accelerating the polishing process, and can also stabilize the polishing. These types of organic acids and amino acids are also referred to as etchants.

Suitable examples of the organic acid or amino acid include carboxylic acids such as formic acid, acetic acid, propionic acid, butyric acid, valeric acid, 2-methylbutyric acid, n-hexanoic acid, 3,3-dimethylbutyric acid, 2-ethylbutyric acid, 4-methylpentanoic acid, n-heptanoic acid, 2-methylhexanoic acid, n-octanoic acid, 2-ethylhexanoic acid, benzoic acid, glycolic acid, salicylic acid, glyceric acid, oxalic acid, malonic acid, succinic acid, glutaric acid, adipic acid, pimelic acid, maleic acid, phthalic acid, malic acid, tartaric acid, citric acid, lactic acid, and the salts thereof; and amino acids such as glycine, L-alanine, β-alanine, L-2-aminobutyric acid, L-norvaline, L-valine, L-leucine, L-norleucine, L-isoleucine, L-alloisoleucine, L-phenylalanine, L-proline, sarcosine, L-ornithine, L-lysine, taurine, L-serine, L-threonine, L-allothreonine, L-homoserine, L-tyrosine, 3,5-diodo-L-tyrosine, β-(3,4-dihydroxyphenyl)-L-alanine, L-thyroxine, 4-hydroxy-L-proline, L-cysteine, L-methionine, L-ethionine, L-lanthionine, L-cystathionine, L-cystine, L-cysteic acid, L-aspartic acid, L-glutamic acid, S-(carboxymethyl)-L-cysteine, 4-aminobutyric acid, L-asparagine, L-glutamine, azaserine, L-arginine, L-canavanine, L-citrulline, d-hydroxy-L-lysine, creatine, L-kynurenine, L-histidine, 1-methyl-L-histidine, 3-methyl-L-histidine, ergothioneine, and L-tryptophan. These organic acids or amino acids can be added singularly, or in combinations of two or more compounds.

Of the organic acids and amino acids listed above, acetic acid, lactic acid, malic acid, citric acid, tartaric acid, glycolic acid, oxalic acid and phthalic acid are preferred as they are readily available.

The quantity of the organic acid and amino acid within the metal polishing composition is typically within a range from 0.01 to 10% by mass, and preferably from 0.02 to 5% by mass, and even more preferably from 0.05 to 2% by mass. Quantities equal to or less than 0.01% by mass may be insufficient to improve polishing rate, whereas at quantities equal to or more than 10% by mass, there is a danger of the etching rate of the metal or metal alloy becoming overly rapid, resulting in an inadequate suppression of dishing, and unsatisfactory planarization.

The metal polishing composition need not contain abrasive grains, although abrasive grains may be added to further accelerate the polishing rate. Examples of suitable abrasive grains include silica, alumina, ceria, and organic abrasive grains, and of these, silica is preferred as it offers a good combination of scratching and polishing properties.

If the quantity of such abrasive grains is too high, then they can cause dishing and scratching, and consequently the quantity of abrasive grains is typically restricted to no more than 30% by mass, and preferably less than 20% by mass, and even more preferably no more than 10% by mass of the metal polishing composition.

In order to achieve a suitable level of polishing, and further improve the planarization of the metal layer, other metal protective film forming agents and anticorrosive agents may also be added to the metal polishing composition, in addition to the film forming compound described above. Examples of these types of metal protective film forming agents and anticorrosive agents include complex forming compounds, which react with the metal, an oxide of the metal, or an ion of the metal, to form an insoluble complex.

Of the possible complex forming compounds, azole compounds are preferred as they provide superior metal protective film formability and excellent anticorrosive properties. Specific examples of suitable azoles include benzimidazole-2-thiol, 2-[2-(benzothiazolyl)]thiopropionic acid, 2-[2-(benzothiazolyl)]thiobutyric acid, 2-mercaptobenzothiazole, 1,2,3-triazole, 1,2,4-triazole, 3-amino-1H-1,2,4-triazole, benzotriazole, 1-hydroxybenzotriazole, 1-dihydroxypropylbenzotriazole, 2,3-dicarboxypropylbenzotriazole, 4-hydroxybenzotriazole, 4-carboxyl-1H-benzotriazole, 4-methoxycarbonyl-1H-benzotriazole, 4-butoxycarbonyl-1H-benzotriazole, 4-octyloxycarbonyl-1H-benzotriazole, 5-hexylbenzotriazole, N-(1,2,3-benzotriazolyl-1-methyl)-N-(1,2,4-triazolyl-1-methyl)-2-ethylhexylamine, tolyltriazole, naphthotriazole, bis[(1-benzotriazolyl)methyl]phosphonic acid, benzimidazole, tetrazole, and the salts thereof. Of these compounds, benzotriazole is preferred.

In order to ensure no reduction in the polishing properties of the metal polishing composition, the quantity of metal protective film forming agents and anticorrosive agents within the metal polishing composition is typically no more than 5% by mass, and preferably no more than 2% by mass, and even more preferably no more than 0.5% by mass.

Furthermore, inorganic acids and their salts, or alkali materials can also be added to the metal polishing composition, provided their addition does not impair the performance or physical characteristics of the composition. Inorganic acids, the salts thereof, or alkali materials assist in maintaining a stable polishing performance, and also function as pH regulators and buffering agents.

Examples of suitable inorganic acids include carbonic acid, phosphoric acid, sulfuric acid, hydrochloric acid, and nitric acid, and suitable salts of these acids include ammonium salts and potassium salts. Examples of suitable alkali materials include sodium hydroxide, potassium hydroxide, potassium carbonate, potassium bicarbonate, and ammonium bicarbonate.

In order to ensure no reduction in the polishing properties of the metal polishing composition, the quantity of inorganic acids, the salts thereof, or alkali materials within the metal polishing composition is typically no more than 10% by mass, and preferably no more than 5% by mass, and even more preferably no more than 1% by mass.

Where necessary, water soluble polymers and surfactants may also be added to the metal polishing composition. By including water soluble polymers and surfactants, the dispersibility of other components such as the film forming compound can be improved.

Examples of suitable water soluble polymers include polyacrylic acid, polymethacrylic acid or the ammonium salt thereof, polyisopropylacrylamide, polydimethylacrylamide, polymethacrylamide, polymethoxyethylene, polyvinyl alcohol, hydroxyethylcellulose, carboxymethylcellulose, carboxyethylcellulose, and polyvinylpyrrolidone.

The surfactants may be cationic, anionic or non-ionic. Examples of suitable cationic surfactants include aliphatic amine salts and aliphatic ammonium salts. Examples of suitable anionic surfactants include fatty acid soaps; carboxylates such as alkyl ether carboxylates; sulfonates such as alkylbenzene sulfonates and alkylnaphthalene sulfonates; sulfate esters such as high alcohol sulfates, and alkyl ether sulfates; and phosphate esters such as alkyl phosphates. Examples of suitable non-ionic surfactants include ethers such as polyoxyethylene alkyl ethers, ether esters such as polyoxyethylene ethers of glycerin esters, and esters such as polyethylene glycol fatty acid esters, glycerin esters, and sorbitan esters.

In order to ensure no reduction in the polishing properties of the metal polishing composition, the quantity added of these water soluble polymers and surfactants is typically no more than 5% by mass, and preferably no more than 1% by mass, and even more preferably no more than 0.5% by mass of the composition.

The metal polishing composition is preferably used within a pH range from 2 to 12, with pH values within a range from 3 to 10 even more preferred, and pH values from 5 to 9.5 the most desirable. In order to adjust the pH to a value within the above range, a variety of materials can be added, including the etchants, inorganic acids, and salts of inorganic acids described above, as well as the oxides or hydroxides of alkali metals or alkaline earth metals.

With a metal polishing composition such as that described above, the film forming compound polymerizes on the metal layer surface, forming a polymer film on the surface of the metal layer, and this polymer film acts as a protective coating, so that when the convex section undergoes mechanical polishing, excess etching of metal other than the excess metal within the concave section is prevented, thereby preventing dishing. Within the convex section, because the protective coating is stripped away with ease, the polishing rate improves, making high speed polishing at low pressures possible. Furthermore, because the polymer film also prevents scratching of the metal layer, the yield also improves.

In addition, the metal polishing composition of the present invention is ideal for the polishing of metal layers that constitute the wiring of multi-layer wiring sections.

Next is a description of one example of a polishing method for a metal layer, and a production method for a wafer, using the type of metal polishing composition described above.

In this polishing method for a metal layer, a polishing apparatus that comprises a holder for holding a wafer, and a polishing plate to which a polishing cloth is attached, can be used. When this type of polishing apparatus is used, a metal polishing composition such as those described above is supplied onto the polishing cloth on the polishing plate of the polishing apparatus, while a wafer comprising the metal layer to be polished is pressed against the polishing cloth, as the polishing plate and the wafer are moved relative to each other to polish the metal layer.

An example of a suitable method of supplying the metal polishing composition onto the polishing pad of the polishing plate is a method in which the composition is supplied in a continuous manner using a pump or the like. The metal polishing composition may be supplied as a single liquid containing all of the components of the composition, or alternatively, a solution of the hydrogen peroxide component, and a liquid containing all the other components could be supplied through separate lines, in order to improve the stability. In those cases where two or more liquids are supplied through separate lines, the liquids can either be mixed together immediately prior to reaching the polishing cloth, or simply supplied onto the polishing cloth from separate lines as separate liquids.

The polishing cloth can utilize typical non-woven fabrics, or foamed polyurethane or the like.

Using this type of polishing method, a wafer with a planarized metal layer can be produced. In a production method for such a wafer, an interlayer insulating film is first formed on the wafer, recesses such as grooves and openings for forming wiring are subsequently formed in the interlayer insulating film on the wafer, and a thin barrier metal layer is then formed on top of the interlayer insulating film. Subsequently, a metal layer for generating the wiring, formed from a metal such as copper, is formed on top of the barrier metal layer so as to fill the recesses, using a plating method or the like. This metal layer is then polished using the polishing method described above, and if required the barrier metal layer and the interlayer insulating film are further polished and planarized, thereby completing the manufacture of a wafer with a planarized metal layer.

The interlayer insulating film can be either an inorganic interlayer insulating film comprising a large quantity of silicon such as a silicon oxide film, HSQ or MSQ, or an organic interlayer insulating film such as a film of benzocyclobutene, and may also utilize a low dielectric constant interlayer insulating film in which holes are provided within the above types of films. The barrier metal layer preferably utilizes a tantalum based metal such as tantalum or tantalum nitride, which offer superior barrier properties.

In the polishing method for a metal layer described above, a metal polishing composition such as those described above is used, so that the film forming compound forms a polymer film on top of the metal layer prior to the polishing process, thereby preventing dishing. It is surmised that within the convex sections, the protective film is stripped away with ease by the polishing, enabling the polishing rate to be increased.

Furthermore, because a production method for a wafer according to the present invention includes a step for polishing the metal layer via the aforementioned polishing method, a wafer with excellent planarity can be manufactured at high speed and low pressure.

### EXAMPLES

As follows is a more detailed description of specifics of the present invention, based on a series of examples, although the present invention is in no way restricted by the examples presented below.

(Polishing Rate Test)

Under the conditions listed below, a metal layer was polished by supplying a metal polishing composition onto the polishing cloth on the polishing plate of a polishing apparatus, while the wafer was pressed against the polishing cloth, as the polishing plate and the wafer were moved relative to each other, and the polishing rate during this process was measured.
Wafer: a silicon wafer with a copper film cut into a sample of size 4×4 cm
Relative speed between wafer and polishing plate: 54 m/minute
Polishing pressure: 10 MPa
Polishing pad: IC1000/SUBA400, manufactured by Rodel Nitta Company Ltd.
Metal polishing composition supply rate: 13 ml/minute
Measurement of polishing rate: calculated from electrical resistance values prior to, and following polishing.
   (Etching Test)

A 2 cm×2 cm copper sheet was immersed in a metal polishing composition, and the etching rate per minute was calculated from the decrease in weight of the copper sheet.

(Polishing Characteristics Test)

In order to evaluate the actual polishing characteristics, a metal layer was polished under the conditions listed below, by supplying a metal polishing composition onto the polishing cloth on the polishing plate of a polishing apparatus, while a patterned wafer was pressed against the polishing cloth, as the polishing plate and the wafer were moved relative to each other, and the step height was measured.
Wafer: a silicon wafer comprising a barrier metal layer of tantalum, and a copper film of 1200 nm in which is formed grooves of depth 500 nm, cut into a sample of size 4×4 cm
Relative speed between wafer and polishing plate: 54 m/minute
Polishing pressure: 30 MPa
Polishing pad: IC1000/SUBA400, manufactured by Rodel Nitta Company Ltd.
Metal polishing composition supply rate: 13 ml/minute Measurement of step height: Using a contact profilometer, the step height in a 100 μm/100 μm line and space pattern was measured. Those cases in which polishing had satisfactorily reduced the step height are described as having superior “step height reduction.”

### Reference Examples 1 to 3

### Polymerizability of Persimmon Tannin

The polymerizability of persimmon tannin was investigated. Persimmon tannin and hydrogen peroxide were combined in a sample bottle in the quantities shown in Table 1, an aqueous solution of copper acetate was added, and the state of the solution was observed.

In the reference example 1, the solution changed to a brown color, and thickened to form a gel. In comparison, in the reference example 3, in which no copper acetate was added, no changes were observed in the state of the solution. In the reference example 2, in which hydrogen peroxide was not added, the color of the solution changed, but gelling did not occur.

In order to confirm that the gel product in the reference example 1 was derived from the persimmon tannin, the infrared spectra of the isolated and dried gel product and the raw material persimmon tannin were analyzed. The spectra were obtained using a KBr method. The raw material persimmon tannin displayed absorptions corresponding with a phenol O—H stretching vibration (3406 cm⁻¹), an aromatic C—H stretching vibration (2933 cm⁻¹), an ester C═O stretching vibration (1697 cm⁻¹), and an aromatic C—C ring stretching vibration (1610 cm⁻¹). The gel product also displayed absorptions corresponding with a phenol O—H stretching vibration (3423 cm⁻¹), an aromatic C—H stretching vibration (2922 cm⁻¹), an ester C═O stretching vibration (1722 cm⁻¹), and an aromatic C—C ring stretching vibration (1624 cm⁻¹), confirming that the gel product is a polymer of the persimmon tannin.

In other words, it is thought that the persimmon tannin underwent an oxidation polymerization with the hydrogen peroxide, with participation by the copper acetate, forming a gel. From this result it is surmised that persimmon tannin will function as a film forming compound, and form a polymer film on top of a copper layer.

TABLE 1

| | Reference | Reference | Reference |
|---|---|---|---|
| | example 1 | example 2 | example 3 |
| Persimmon tannin | 0.1 | 0.1 | 0.1 |
| (% by mass) | | | |
| Copper acetate | 0.14 | 0.14 | 0 |
| (% by mass) | | | |
| Hydrogen peroxide | 0.2 | 0 | 0.2 |
| (% by mass) | | | |
| State of solution | The viscosity of the | No gelling | No |
| | solution gradually | occurred | change. |
| | increased, with | even after | |
| | partial gelling | 60 minutes. | |
| | after 60 minutes. | | |

### Examples 1 to 3

### Comparative Example 1

Using persimmon tannin as a film forming compound, malic acid as an organic acid, and hydrogen peroxide as an oxidizing agent, metal polishing compositions of the examples 1 to 3 and the comparative example 1 were prepared with the compositions shown in Table 2, and subsequently subjected to the etching test described above. In the example 1, which used a metal polishing composition comprising persimmon tannin, malic acid, and hydrogen peroxide, a film was formed rapidly on the surface of the copper sheet, and etching was suitably suppressed. This film was washed with water, dried, and the infrared spectrum then recorded and analyzed, in a similar manner to the reference example 1. The film displayed absorptions corresponding with a phenol O—H stretching vibration (3418 cm⁻¹), an aromatic C—H stretching vibration (2925 cm⁻¹), an ester C═O stretching vibration (1711 cm⁻¹), and an aromatic C—C ring stretching vibration (1620 cm⁻¹), confirming that the film was a polymer derived from persimmon tannin.

Furthermore, in both the example 2, which used a metal polishing composition containing no malic acid, and the example 3, which used a metal polishing composition containing no hydrogen peroxide, no etching occurred, and no gel-like film was confirmed on the surface of the copper sheet.

In contrast, in the comparative example 1, which used a composition containing malic acid and hydrogen peroxide, but with no persimmon tannin, the solution of the metal polishing composition changed to a light blue color, and the wafer was etched excessively.

TABLE 2

| | | | | Comparative |
|---|---|---|---|---|
| | Example 1 | Example 2 | Example 3 | example 1 |
| Persimmon | 1.0 | 1.0 | 1.0 | none |
| tannin | | | | |
| (% by mass) | | | | |
| Malic acid | 1.0 | none | 1.0 | 1.0 |
| (% by mass) | | | | |
| Hydrogen | 2.0 | 2.0 | none | 2.0 |
| peroxide | | | | |
| (% by mass) | | | | |
| Etching rate | 41 | 0 | 0 | 104 |
| (nm/minute) | | | | |
| State of | Suitable level | No etching. | No etching. | Solution |
| solution | of etching. | After 60 | After 120 | changed to a |
| | After several | minutes, no | minutes, no | light blue |
| | minutes, a | gel | gel | color, and |
| | transparent gel | confirmed on | confirmed on | copper sheet |
| | with a | the surface | the surface | was etched |
| | thickness of | of the | of the | excessively. |
| | several mm had | copper | copper | |
| | bonded to the | sheet. | sheet. | |
| | copper sheet. | | | |

### Examples 4 to 10

### Comparative Examples 2 to 6

By combining either persimmon tannin or Chinese gallotannin as a film forming compound, benzotriazole as an anticorrosive agent, hydrogen peroxide as an oxidizing agent, colloidal silica as abrasive grains, and the organic acid or amino acid shown in the following table, metal polishing compositions of the examples 4 to 10 and the comparative examples 2 to 6 were prepared with the compositions shown in Table 3 and Table 4 respectively. The polishing rate and the etching rate for each composition was measured using a blanket wafer (wafer) with a thin film of copper (metal layer) formed thereon. The results are shown in Table 3 and Table 4.

TABLE 3

| | | Example | Example | Example | Example | Example | Example | Example |
|---|---|---|---|---|---|---|---|---|
| | | 4 | 5 | 6 | 7 | 8 | 9 | 10 |
| Polymerizable | persimmon | 0.15 | 0.05 | 0.05 | 0.05 | 0.05 | | 0.05 |
| | tannin | | | | | | | |
| compound (% by | Chinese | | | | | | 0.05 | |
| mass) | gallo- | | | | | | | |
| | tannin | | | | | | | |

| | | | | | | | |
|---|---|---|---|---|---|---|---|
| Anticorrosive agent | | | 0.01 | 0.01 | 0.01 | 0.01 | 0.01 |
| (% by mass) | | | | | | | |
| Oxidizing agent | 4.0 | 4.0 | 4.0 | 4.0 | 4.0 | 4.0 | 4.0 |
| (% by mass) | | | | | | | |
| Abrasive grains | | | | | | | 1.0 |
| (% by mass) | | | | | | | |
| Organic acid, amino | | citric | citric | lactic | oxalic | citric | citric |
| acid (% by mass) | | acid | acid | acid | acid | acid | acid |
| | | 0.5 | 0.5 | 0.5 | 0.5 | 0.5 | 0.5 |
| Polishing pressure | 100 | 100 | 100 | 100 | 100 | 100 | 100 |
| (gf/cm²) | | | | | | | |
| Polishing rate | 173 | 722 | 873 | 503 | 781 | 642 | 998 |
| (nm/minute) | | | | | | | |
| Etching rate | 0 | 62 | 65 | 26 | 8 | 55 | 60 |
| (nm/minute) | | | | | | | |

Anticorrosive agent: benzotriazole,
oxidizing agent: hydrogen peroxide,
abrasive grains: colloidal silica

TABLE 4

| | | Comparative | Comparative | Comparative | Comparative | Comparative |
|---|---|---|---|---|---|---|
| | | example 2 | example 3 | example 4 | example 5 | example 6 |
| Polymerizable | persimmon | | | | | |
| | tannin | | | | | |
| compound (% by | Chinese | | | | | |
| mass) | gallo- | | | | | |
| | tannin | | | | | |

| | | | | | |
|---|---|---|---|---|---|
| Anticorrosive agent | | 0.01 | 0.01 | 0.01 | |
| (% by mass) | | | | | |
| Oxidizing agent | 4.0 | 4.0 | 4.0 | 4.0 | 4.0 |
| (% by mass) | | | | | |
| Abrasive grains | | | | | |
| (% by mass) | | | | | |
| Organic acid, amino | citric acid | citric acid | lactic acid | oxalic acid | |
| acid (% by mass) | 0.5 | 0.5 | 0.5 | 0.5 | |
| Polishing pressure | 100 | 100 | 100 | 100 | 100 |
| (gf/cm²) | | | | | |
| Polishing rate | 499 | 336 | 263 | 554 | 1 |
| (nm/minute) | | | | | |
| Etching rate | 52 | 32 | 29 | 0 | 0 |
| (nm/minute) | | | | | |

Anticorrosive agent: benzotriazole,
oxidizing agent: hydrogen peroxide,
abrasive grains: colloidal silica

In the example 4, despite the fact that the lack of an etchant resulted in an etching rate of 0, a polymer film derived from the persimmon tannin was formed on the blanket wafer, resulting in a polishing rate of 173 nm/minute.

The composition of the example 5 comprised both persimmon tannin and citric acid, and consequently the polishing rate improved relative to the example 4.

The composition of the example 6 comprised benzotriazole in addition to the persimmon tannin, hydrogen peroxide and citric acid, and consequently the polishing rate improved even further than that of the example 5. In other words, a synergistic effect was exhibited between the persimmon tannin and the benzotriazole.

The compositions of the example 7 and the example 8 were identical with the composition of the example 6, with the exception of altering the etchant to lactic acid and oxalic acid respectively, and both compositions displayed fast polishing rates.

In the example 9, Chinese gallotannin was used as the film forming compound, and a similar effect to that of persimmon tannin was observed, with a fast polishing rate.

The composition of the example 10 comprised an additional 1% by mass of colloidal silica with an average particle size of 0.12 nm, and the polishing rate improved markedly.

In contrast, the compositions of the comparative examples 2 to 6 comprised no persimmon tannin or Chinese gallotannin as a film forming compound, and consequently a satisfactory increase in polishing rate was not observed. In other words, if the comparative example 6 is compared with the example 2, the comparative example 2 with the example 5, the comparative example 3 with the example 6, the comparative example 4 with the example 7, and the comparative example 5 with the example 8, then in each case, the comparative example containing no persimmon tannin displayed a lower polishing rate.

### Example 11

An aqueous solution comprising a mixture of 0.15% by mass of malic acid, 0.15% by mass of polyacrylic cid (molecular weight 25,000), 0.2% by mass of benzotriazole, 0.05% by mass of persimmon tannin, and 9.0% by mass of hydrogen peroxide was used as a metal polishing composition. Using this metal polishing composition, the polishing rate as determined by the polishing rate test described above was 350 nm/minute, and the etching rate as determined by the etching rate test described above was 1 nm/minute.

A wafer (wafer) on which a pattern had been formed, and with a tantalum barrier film, was polished using this metal polishing composition. During polishing, a polishing characteristics test was conducted in accordance with the method described above. The wafer was polished until the tantalum barrier film was exposed, and when the step height was then measured, the result was 35 nm. This result indicated a superior step height reduction, and minimal dishing. Furthermore, absolutely no scratching was detectable on the wafer surface. By incorporating persimmon tannin as a film forming compound in this manner, the polishing rate was able to be improved without any deterioration in the step height reduction or dishing.

### Comparative Example 7

With the exception of not adding the persimmon tannin, a metal polishing composition was prepared in the same manner as the example 11. The polishing rate as determined by the above polishing rate test was 256 nm/minute, and the etching rate as determined by the above etching rate test was 1 nm/minute. Furthermore, when a patterned wafer was polished in the same manner as the example 11 and the step height on the wafer then measured, the result was 34 nm. There was absolutely no scratching on the wafer surface.

### INDUSTRIAL APPLICABILITY

According to a composition for polishing a metal of the present invention, because dishing can be prevented, the planarity can be improved, and the polishing rate for polishing metal layers, and particularly copper layers, can be improved, enabling high speed polishing at low pressure. Furthermore, because scratching of the metal layer is also prevented, the yield improves. Moreover, the metal polishing composition is cheap, and consequently industrially viable.

In addition, in a polishing method for a metal layer according to the present invention, the metal layer can be planarized by high speed polishing at low pressure, and in a production method for a wafer according to the present invention, a wafer of superior planarity can be manufactured at low pressure.

1. A metal polishing composition used for polishing a metal layer, comprising a film forming compound which polymerizes on a surface of the metal layer, forming a polymer film on the surface of the metal layer.

2. The metal polishing composition according to claim 1, wherein the film forming compound polymerizes under catalysis from one or more materials selected from a group consisting of a metal included in the metal layer, oxides of the metal, and ions of the metal.

3. The metal polishing composition according to claim 1, wherein the film forming compound is at least one compound selected from a group consisting of phenol compounds and aromatic diamine compounds.

4. The metal polishing composition according to claim 3, wherein the phenol compound comprises at least two phenolic hydroxyl groups.

5. The metal polishing composition according to claim 4, wherein the phenol compound comprising at least two phenolic hydroxyl groups is at least one compound selected from a group consisting of catechol, pyrogallol, gallic acid, tannic acid, and polyphenols.

6. The metal polishing composition according to claim 5, wherein the polyphenol is a tannin.

7. The metal polishing composition according to claim 1, further comprising an oxidizing agent, and wherein said polymerization is an oxidation polymerization.

8. The metal polishing composition according to claim 3, wherein the oxidizing agent is at least one compound selected from a group consisting of oxygen, ozone, hydrogen peroxide, and ammonium persulfate.

9. The metal polishing composition according to claim 1, further comprising an organic acid and/or an amino acid.

10. The metal polishing composition according to claim 9, wherein the organic acid is at least one compound selected from a group consisting of acetic acid, lactic acid, malic acid, citric acid, tartaric acid, glycolic acid, oxalic acid, and phthalic acid.

11. The metal polishing composition according to claim 1, further comprising a complex forming compound, which reacts with the metal included in the metal layer, an oxide of the metal, or an ion of the metal, and forms an insoluble complex.

12. The metal polishing composition according to claim 11, wherein the complex forming compound is an azole.

13. The metal polishing composition according claim 12, wherein the azole is benzotriazole.

14. The metal polishing composition according to claim 1, further comprising abrasive grains.

15. The metal polishing composition according to claim 14, wherein the abrasive grains utilize at least one compound selected from a group consisting of silica, alumina, ceria, and organic abrasive grains.

16. The metal polishing composition according to claim 1, used for polishing a metal layer which is formed on a top of a wafer which contains recesses so as to fill and cover the recesses.

17. The metal polishing composition according to claim 16, wherein a barrier metal layer is formed on a top of the wafer which contains recesses.

18. The metal polishing composition according to claim 1, wherein the metal included in the metal layer is either copper or an alloy comprising copper.

19. The metal polishing composition according to claim 17, wherein the barrier metal layer is formed from a tantalum based metal.

20. A polishing method for a metal layer, comprising a step of polishing and planarizing the metal layer using the metal polishing composition according to any one of claims 1 to 19.

21. A production method for a wafer, comprising a step in which the polishing method for a metal layer according to claim 20 is used for polishing and planarizing a metal layer, which is formed on top of a wafer which contains recesses so as to fill and cover the recesses.
